(19) United States
(12) Patent Application Publication
(10) Pub. No.: US 2008/0213435 A1
(43) Pub. Date: Sep. 4, 2008

(54) SOFT SUGAR COATING FOR A PANNING PROCESS

(76) Inventors: Constance Jo Enevold, Augusta, MI (US); Richard Norris Flaget, Richland, MI (US); Sylvia Lynn Schonauer, Battle Creek, MI (US)

Correspondence Address: Randall L. Shoemaker;Dickinson Wright PLLC, Ste. 2000, 38525 Woodward Ave., Bloomfield Hills, MI, 48304-2970, US

(21) Appl. No.: 12/041,129

(22) Filed: Mar. 3, 2008

Related U.S. Application Data
(60) Provisional application No. 60/892,279, filed on Mar. 1, 2007.

(51) Int. Cl. A23L 1/48; A23L 1/27; A23P 1/08; A23G 3/54; A23L 1/09

(52) U.S. Cl. 426/96; 426/293

(57) ABSTRACT

Disclosed is an engrossing syrup for a pan coating process and a process that enables one to coat a food piece with a soft sugar coating that retains its softness over time. The process also allows the coating to occur at low coating temperatures. In addition, the process produces a thinner and softer coating to provide a novel taste and texture to the coated food piece. The engrossing syrup can be used to coat a wide variety of types of food pieces using a pan coating process.

### RELATED APPLICATIONS

This application claims the benefit of U.S. Provisional Application No. 60/892,279, filed Mar. 1, 2007.

### STATEMENT REGARDING FEDERALLY SPONSORED RESEARCH

NONE

### TECHNICAL FIELD

This invention relates generally to a panning process for coating food pieces and, more particularly, to an engrossing syrup and a panning process adapted to produce a soft sugar-based outer coating on food pieces that remains soft after application.

### BACKGROUND OF THE INVENTION

Panning of food pieces to produce an outer coating on the food piece is well known in the art. Panning involves rotating a food piece to be coated in a pan or kettle while drizzling in a coating material. The rotation rate, temperature and drizzle rate are selected to ensure complete and full coating of the food pieces. The coating is actually built up as a plurality of layers on the food piece. The most common coatings include fat-based confectionery coatings such as chocolate or sugar-based coatings such as found on jelly beans. In the present invention we are concerned with sugar-based coatings.

Fat-based coatings can either use cocoa butter when they are a chocolate coating or vegetable oil when they are used to create other fat-based coatings. These have long been used to cover a multitude of types of food pieces including nuts, dried fruit, chocolate bits, or sugar based candies. Fat-based coatings are typically soft textured and prone to loss of integrity at temperatures above the melting point of the constituent fat.

As an overall class sugar-based coatings tend to be harder than fat-based coatings. One class of sugar-based coatings is comprised of multiple layers of an engrossing syrup that is a thin sugar syrup that must be dried between applications and that results in a very thin, hard, brittle shell due to formation of very small sugar crystals during the panning process. This type of panning process does not include use of a drying sugar between layers of the engrossing syrup and this process is not the subject of the present invention. Common food pieces coated in this manner include M&M's®, skittles®, chewing gum pieces, and other hard coated candy pieces.

Another class of sugar-based coatings comprises alternating applications of an engrossing syrup comprising a liquid syrup and a drying sugar that builds faster, thicker layers. This typically results in a non-brittle but fairly hard shell due to larger sugar crystals present in these coatings. The most common food pieces coated in this manner are jelly beans. This process is the subject of the present invention.

The panning process according to the present invention can be use to coat a variety of types of food pieces. The potential food pieces include both high density food pieces having a specific gravity of 1.0 or greater and also low density food pieces having a specific gravity of less than 1.0. High density food pieces include, by way of example only and not limitation, hard candies, confections, nuts, caramels, chocolate pieces, starch molded pieces, dual textured confections having a liquid center surrounded by a solid outer layer, dried fruit and dried fruit pieces, nougats, jelly beans, or certain baked goods. Low density food pieces include, by way of example only and not limitation, certain low density baked goods, low density confection pieces, low density ready to eat cereal pieces, mini cookies, and baked wafers. In addition, food pieces that can be used in the present invention include both high and low density food pieces as described above that have been first coated with a chocolate coating, a compound coating, or a yogurt-based coating prior to pan coating by the present process.

Often the food pieces to be coated are first covered with an initial layer of material to prepare the food pieces for accepting the panning applied coating. The composition of the initial layer will depend on the nature of the food piece. A particle barrier such as a sanding sugar is used on sugar-based food pieces to prevent them from sticking to each other. A hydrocolloid film barrier is used when the food piece and the coating are formed from disparate materials such as for example a sugar and a fat.

The prepared food pieces are then coated with a first coating of an engrossing syrup. The engrossing syrups for jelly bean type non-brittle hard coatings comprise water, sugar, and some corn syrup with colors and flavors being optional. Typically in these prior art engrossing syrups the ratio of corn syrup solids to sugar solids is from 1:1 to 3:1, more usually from 2:1 to 3:1. Hydrocolloids may be included to control syrup viscosity. Typically the engrossing syrup is formulated to have a high solids content of from 77 to 80%. The panning process typically is conducted using engrossing syrups that are applied at temperatures of from about 110 to 160° F. (43.3 to 71.1° C.). After an initial coating with the engrossing syrup the food pieces are then coated with a first drying sugar of granulated sugar with a uniform and large granular size. Then the engrossing syrup is applied again to form a second coating followed by a second drying sugar coating wherein the drying sugar is Baker's sugar having a smaller granular size than the first drying sugar coating. The second drying sugar coating tends to fill in the gaps between the granules of the first drying sugar. Then a third application of the engrossing syrup is done followed by a third drying sugar coating of powdered sugar is applied. The process can involve additional coatings of engrossing syrup and drying sugar as required for a particular food piece. Finally, a polishing step takes place usually using a Carnauba wax or a shellac to smooth and seal the coated food piece. Typically the panning applied coating comprises from 33 to 50% by weight of the final food piece. In the prior art it is taught that this sequence of gradually smaller particle sized drying sugars is required to build up a coating.

As discussed above the panning applied coating of a jelly bean is typically a non-brittle hard shell, however, even the non-brittle hard shell can become brittle and crackly over time. There are times when it would be desirable to provide a softer chewier coating using a panning process. It would be especially desirable to maintain a soft sugar shell texture in cases when it is applied over a soft texture piece or soft texture fat based coating such as a chocolate coating, a yogurt-based coating or a compound coating.

### SUMMARY OF THE INVENTION

In general terms, this invention provides an engrossing syrup for a panning coating process and a panning coating process that allows one to create a soft sugar-based shell that remains soft over time and does not turn brittle with storage. The present invention is an engrossing syrup for a panning coating process comprising corn syrup, sugar, water, a film forming agent and optionally color or flavor additives wherein the weight ratio of corn syrup solids to sugar solids in the syrup is from 3.3:1 to 6:1, more preferably from 3.5:1 to 5:1. In addition, the total solids level of the engrossing syrup of the present invention is lower than the typical engrossing syrup. It is preferably from 65 to 72% and more preferably from 65 to 70%. This solids level is far below the more usual level of 77 to 80% found in the prior art engrossing syrups. The process involves use of only powdered sugar as the drying sugar. The high ratio of corn syrup solids to sugar solids, the low solids level and the use of only powdered sugar as the drying sugar creates the softer coating of the present invention. The prior art has always used engrossing syrups having much higher solids levels and graduated sizes of drying sugars.

These and other features and advantages of this invention will become more apparent to those skilled in the art from the detailed description of a preferred embodiment.

### DETAILED DESCRIPTION OF A PREFERRED EMBODIMENT

Snack foods such as jelly beans, M&M's®, Skittles®, yogurt coated raisins, chocolate covered nuts, hard coated gums, starch molded fruit snacks and other confections are typically coating using a panning process. Typically, the panning process used to coat these food pieces involves use of an engrossing syrup solution that is heated to temperatures of from 110 to 160° F. (43.3 to 71.1° C.) and formation of a thin brittle hard shell or a thicker hard shell.

The present invention includes a unique engrossing syrup in combination with a specific drying sugar in a process that is unlike the prior art. The inventors have found that by having a high ratio of corn syrup solids to sugar solids in the engrossing syrup of from 3.3:1 to 6:1, more preferably from 3.5:1 to 5:1, and by using only powdered sugar as the drying sugar one can develop an outer coating that remains soft over time. The total amounts of corn syrup and sugar used in the engrossing syrup are dependent on the desired final solids level and the level of the other components. The inventors have found that a lower ratio of DE 42 corn syrup solids to sugar solids of 2.5:1 in the engrossing syrup does not result in a soft coating that retains its softness over time even if powdered sugar is used as the drying sugar. Preferably the engrossing syrup uses corn syrup having a DE of 42 or greater. The engrossing syrup also includes 2 to 20% by weight of at least one film forming agent. The preferred film forming agents are modified food starches, dextrins, gum Arabic, or mixtures of these. Examples include tapioca or maize dextrins, waxy maize starch, or modified starches such as modified corn starch. The preferred level of film former is dependent on its identity. Dextrins are preferably used at levels of from 10 to 20%, more preferably from 12 to 17% by weight. The modified food starches are preferably used at levels of from 2 to 10%, more preferably from 4 to 10%. Gum Arabic is preferably used at a level of from 3 to 15%, more preferably from 3 to 10%. The engrossing syrup also comprises from 10 to 20% by weight of water to provide a final solids level of from 65 to 72%. The engrossing syrup can also include color agents at levels of from 0.1 to 1% by weight. The engrossing syrup can optionally include additional flavors at levels of from 0.1 to 5% by weight. Preferably the engrossing syrup of the present invention has a solids level of from 65 to 72%, which is much lower than the typical engrossing syrup as discussed above which has solids levels of 77% or greater. The engrossing syrup of the present invention can be applied at temperatures of 100° F. (37.8° C.) or less, preferably at temperatures of from 100 to 80° F. (37.8 to 26.6° C.), thus any underlying temperature sensitive coating remains attached to the food pieces and is stable of course the present engrossing syrup can also be used at the more typical temperatures of 110 to 160° F. (43.3 to 71.1° C.).

The present process also comprises using only confectioners sugar, also known as powdered sugar, as the sole drying sugar during the panning process. In the present specification and claims powdered sugar and confectioner's sugar are used interchangeably. Preferably, the powdered sugar has a particle size of 37 microns or less, this is commonly designated as 6 X confectioner's sugar or smaller using the usual designations for powdered sugar. Using the X designation a higher number represents a finer particle size, thus 10 X powdered sugar is smaller than 6 X. This is unlike the typical panning process which comprises using graduated sizes of sugar at each drying step starting with granulated sugar and moving down to confectioner's sugar in the final coating. It was unexpected that the present process would be able to build a coating on food pieces. It was believed that the graduated drying sugars were required to build a smooth coating. The present process produces a smooth, much thinner and softer coating through use of the specific engrossing syrup and the powdered sugar as the drying sugar. Preferably the outer sugar coating is added in two to five repetitions of alternating the engrossing syrup with the drying sugar of powdered sugar. As a final optional step the coated pieces can be polished and waxed using approximately 0.05% by weight of a carnauba wax as is known in the art. The polished and waxed pieces are then packaged, preferably in high moisture barrier packaging to prevent the pieces from exposure to moisture during storage.

As discussed above the panning process according to the present invention can be used to coat a variety of types of food pieces. The potential food pieces include both high density food pieces having a specific gravity of 1.0 or greater and also low density food pieces having a specific gravity of less than 1.0. High density food pieces include, by way of example only and not limitation, hard candy pieces, confection pieces, nuts and nut pieces, caramel pieces, chocolate pieces, starch molded pieces, dual textured confection pieces having a liquid center surrounded by a solid outer layer, dried fruits and dried fruit pieces, nougat pieces, jelly beans, certain high density baked goods or certain high density ready to eat cereal pieces. Low density food pieces include, by way of example only and not limitation, certain low density baked goods, low density confection pieces, low density ready to eat cereal pieces, mini cookies, and baked wafers. In addition, food pieces that can be used in the present invention include both high and low density food pieces as described above that have been first coated with a chocolate coating, a compound coating, or a yogurt-based coating prior to pan coating by the present process. Preferably, the coating comprises 25% or less of the final food piece when the food piece is a high density food piece. More preferably when the food piece is a high density food piece the final coated piece comprises 80 to 82% by weight of food piece, 3 to 4% by weight of engrossing syrup and from 17 to 14% by weight of confectioners sugar all based on the total weight. This coating is much thinner than a typical panning process coating, which usually is from 33 to 50% by weight of the final coated food piece. When the food piece is a low density food piece the coating according to the present invention is still a thin coating, however, due to its density the coating may comprise more than 25% by weight of the final food piece although it will be a very thin coating.

### ENGROSSING SYRUP EXAMPLE I

An engrossing syrup is created comprising 50.45% by weight corn syrup 42 DE, 13.95% by weight tapioca dextrin, 19.85% by weight water, 13.65% by weight sugar and 2.1% by weight of colors and flavors. In this engrossing syrup the ratio of corn syrup solids to sugar solids is 3.35:1. The drying sugar used is 6 X powdered sugar. The panning process is conducted at a room temperature of 64 to 74° F. (17.7 to 23.3° C.). The food piece is a starch molded fruit snack. The panning process is to alternate coatings of engrossing syrup with powdered sugar as the drying sugar, for at least three repetitions. The food pieces are then sealed, waxed and polished with 0.044% by weight of a carnauba wax.

### ENGROSSING SYRUP EXAMPLE II

An engrossing syrup is created comprising 59.90% by weight corn syrup 42 DE, 6.20% by weight oxidized waxy maize starch, 16.51% by weight water, 15.29% by weight sugar and 2.1% by weight of colors and flavors. In this engrossing syrup the ratio of corn syrup solids to sugar solids is 3.51:1. The drying sugar used is 6 X powdered sugar. The panning process is conducted at a room temperature of 64 to 74° F. (17.7 to 23.3° C.). The food piece is a starch molded fruit snack. The panning process is to alternate coatings of engrossing syrup with powdered sugar as the drying sugar, for at least three repetitions. The food pieces are then sealed, waxed and polished with 0.044% by weight of a carnauba wax.

### ENGROSSING SYRUP EXAMPLE III

An engrossing syrup is created comprising 60.68% by weight corn syrup 42 DE, 4.65% by weight gum Arabic, 16.51% by weight water, 16.06% by weight sugar and 2.1% by weight of colors and flavors. In this engrossing syrup the ratio of corn syrup solids to sugar solids is 3.36:1. The drying sugar used is 6 X powdered sugar. The panning process is conducted at a room temperature of 64 to 74° F. (17.7 to 23.3° C.). The food piece is a starch molded fruit snack. The panning process is to alternate coatings of engrossing syrup with powdered sugar as the drying sugar, for at least three repetitions. The food pieces are then sealed, waxed and polished with 0.044% by weight of a carnauba wax.

The preferred components of the engrossing syrup according to the present invention are 10 to 20% by weight water, 2 to 20% by weight of a film forming agent, and a mixture of corn syrup and sugar in a weight ratio of corn syrup solids to sugar solids of from 3.3:1 to 6:1 and a final total solids level of from 65 to 72%. Optionally the engrossing syrup has from 0.1 to 1% by weight of color and from 0.1 to 5% by weight of flavor. An engrossing syrup prepared according to the present invention can be used in a panning process to coat a wide variety of low specific gravity and high specific gravity food pieces. High density food pieces include, by way of example only and not limitation, hard candy pieces, confection pieces, nuts and nut pieces, caramel pieces, chocolate pieces, starch molded pieces, dual textured confection pieces having a liquid center surrounded by a solid outer layer, dried fruits and dried fruit pieces, nougat pieces, jelly beans, certain high density baked goods or certain high density ready to eat cereal pieces. Low density food pieces include, by way of example only and not limitation, low density baked goods, low density confection pieces, low density ready to eat cereal pieces, mini cookies, and baked wafers. In addition, food pieces that can be used in the present invention include both high and low density food pieces as described above that have been first coated with a chocolate coating, a compound coating, or a yogurt-based coating prior to pan coating by the present process. The engrossing syrup of the present invention can be applied at the high temperatures typically used of from 110 to 160° F. (43.3 to 71.1° C.), but it can also be applied at lower temperatures of 100° F. (37.8° C.) or less.

The foregoing invention has been described in accordance with the relevant legal standards, thus the description is exemplary rather than limiting in nature. Variations and modifications to the disclosed embodiment may become apparent to those skilled in the art and do come within the scope of the invention. Accordingly, the scope of legal protection afforded this invention can only be determined by studying the following claims.

We claim:

1. A food piece having an outer sugar coating, said sugar coating comprising a plurality of alternating layers of an engrossing syrup layer and a drying sugar layer:
said engrossing syrup comprising corn syrup, sugar, at least one film forming agent and water, wherein said engrossing syrup has a weight ratio of corn syrup solids to sugar solids of from 3.3:1 to 6:1 and said at least one film forming agent is selected from the group consisting of 3 to 15% by weight of gum Arabic, 10 to 20% by weight of a dextrin, 2 to 10% by weight of a modified food starch, and mixtures thereof, all weights based on the total weight of the engrossing syrup;
said engrossing syrup having a total solids level of from 65 to 72%; and
said drying sugar consisting essentially of powdered sugar.

2. The food piece as recited in claim 1 wherein said weight ratio of said corn syrup solids to said sugar solids is from 3.5:1 to 5:1 in said engrossing syrup.

3. The food piece as recited in claim 1 wherein said sugar coating comprises 25% or less by weight of the total weight of the coated food piece.

4. The food piece as recited in claim 1 wherein said engrossing syrup has a total solids level of from 65 to 70%.

5. The food piece as recited in claim 1 wherein said at least one film forming agent comprises gum Arabic present in an amount of from 3 to 10% by weight.

6. The food piece as recited in claim 1 wherein said at least one film forming agent comprises a dextrin present in an amount of from 12 to 17% by weight.

7. The food piece as recited in claim 1 wherein said film forming agent comprises a modified food starch present in an amount of from 4 to 10% by weight.

8. The food piece as recited in claim 1 wherein said food piece further comprises an inner coating of a chocolate coating, a compound coating or a yogurt-based coating applied to said food piece prior to application of said outer sugar coating.

9. The food piece as recited in claim 1 wherein said food piece comprises a high density food piece having a specific gravity of 1.0 or greater.

10. The food piece as recited in claim 9 wherein said food piece comprises a hard candy piece, a confection piece, a nut, a nut piece, a caramel piece, a chocolate piece, a starch molded piece, a dual textured confection piece having a liquid center surrounded by a solid outer layer, a dried fruit, a dried fruit piece, a nougat piece, a jelly bean, a high density baked good, or a high density ready to eat cereal piece.

11. The food piece as recited in claim 1 wherein said food piece comprises a low density food piece having a specific gravity of less than 1.0.

12. The food piece as recited in claim 11 where in said food piece comprises a low density baked good, a low density confection piece, a low density ready to eat cereal piece, a mini cookie, or a baked wafer.

13. The food piece as recited in claim 1 wherein said engrossing syrup further comprises 0.1 to 1.0% by weight based on the total weight of at least one color.

14. The food piece as recited in claim 1 wherein said engrossing syrup further comprises 0.1 to 5% by weight based on the total weight of at least one flavor.

15. The food piece as recited in claim 1 comprising at least three alternating layers of said engrossing syrup layer and said drying sugar layer:

16. A process for applying an outer sugar coating to a food piece by a panning process comprising the steps of:
a) providing a food piece;
b) providing an engrossing syrup having a total solids level of from 65 to 72% and comprising corn syrup, sugar, at least one film forming agent and water, said engrossing syrup having a weight ratio of corn syrup solids to sugar solids of from 3.3:1 to 6:1 and said at least one film forming agent selected from the group consisting of 3 to 15% by weight of gum Arabic, 10 to 20% by weight of a dextrin, 2 to 10% by weight of a modified food starch, and mixtures thereof, all weights based on the total weight of the engrossing syrup;
c) providing a drying sugar consisting essentially of powdered sugar; and
d) applying a plurality of layers of said engrossing syrup followed by said drying sugar to said food piece in a pan coating apparatus thereby forming an outer sugar coating on said food piece.

17. The process as recited in claim 16 wherein step a) comprises providing as the food piece a high density food piece having a specific gravity of 1.0 or greater.

18. The process as recited in claim 17 wherein step a) comprises providing as the food piece a hard candy piece, a confection piece, a nut, a nut piece, a caramel piece, a chocolate piece, a starch molded piece, a dual textured confection piece having a liquid center surrounded by a solid outer layer, a dried fruit, a dried fruit piece, a nougat piece, a jelly bean, a high density baked good, or a high density ready to eat cereal piece.

19. The process as recited in claim 16 wherein step a) comprises providing as the food piece a low density food piece having a specific gravity of less than 1.0.

20. The process as recited in claim 19 wherein step a) comprises providing as the food piece a low density baked good, a low density confection piece, a low density ready to eat cereal piece, a mini cookie, or a baked wafer.

21. The process as recited in claim 16 wherein step a) comprises providing a food piece that has previously been coated with a chocolate coating, a compound coating or a yogurt-based coating.

22. The process as recited in claim 16 wherein step b) comprises providing an engrossing syrup wherein the weight ratio of corn syrup solids to sugar solids is from 3.5:1 to 5:1.

23. The process as recited in claim 16 wherein step b) comprises providing an engrossing syrup having a solids level of from 65 to 70%.

24. The process as recited in claim 16 wherein step b) comprises providing gum Arabic as the at least one film forming agent in an amount of from 3 to 10% by weight.

25. The process as recited in claim 16 wherein step b) comprises providing a dextrin as the at least one film forming agent in an amount of from 12 to 17% by weight.

26. The process as recited in claim 16 wherein step b) comprises providing a modified food starch as the at least one film forming agent in an amount of from 4 to 10% by weight.

27. The process as recited in claim 16 wherein step b) comprises providing an engrossing syrup further comprising 0.1 to 1% by weight of at least one color.

28. The process as recited in claim 16 wherein step b) comprises providing an engrossing syrup further comprising 0.1 to 5% by weight of at least one flavor.

29. The process as recited in claim 16 wherein step d) further comprises applying the plurality of layers at a temperature of from 110 to 160° F.

30. The process as recited in claim 16 wherein step d) further comprises applying the plurality of layers at a temperature of from 100° F. or less.

31. The process as recited in claim 16 wherein step d) comprises applying the plurality of layers of the engrossing syrup and the powdered sugar to the food piece in an amount such that the sugar coating comprises 25% by weight or less of a total weight of the coated food piece.

32. The process as recited in claim 16 wherein step d) comprises applying at least three alternating layers of the engrossing syrup and the powdered sugar to the food piece.
